(19) United States
(12) Patent Application Publication
(10) Pub. No.: US 2005/0151019 A1
(43) Pub. Date: Jul. 14, 2005

(54) Electrically pressurized on-board inert gas generation system

(76) Inventor: Curtis Edgar Stevens, Irvine, CA (US)

Correspondence Address: DON W. BULSON, 1621 EUCLID AVENUE / 19TH FLOOR, RENNER, OTTO, BOISSELLE & SKLAR, LLP, CLEVELAND, OH, 44115, US

(21) Appl. No.: 10/934,163

(22) Filed: Sep. 3, 2004

Related U.S. Application Data
(60) Provisional application No. 60/531,007, filed on Dec. 18, 2003.

(51) Int. Cl. B64D 37/00

(52) U.S. Cl. 244/135 R

(57) ABSTRACT

An on-board inert gas generation system that provides inert gas to a fuel tank of an aircraft. The system includes an air compressor for providing a supply of compressed air, the air compressor being driven by a compressor motor. The system further includes a separator for separating the inert gas from the compressed air provided by the air compressor, the inert gas being substantially oxygen depleted. In addition, the system includes an output for delivering the inert gas from the separator to the fuel tank, and a ground fan for providing air flow to cool the compressed air prior to the compressed air being separated by the separator, the ground fan being driven by a ground fan motor. Still further, the system includes an inverter/controller circuit for providing controlled electrical power to the compressor motor to control at least one of speed and torque of the compressor motor based on feedback provided from the compressor motor, and also providing the controlled electrical power to drive the ground fan motor.

This application claims priority under 35 U.S.C. §119 to U.S. Provisional Application No. 60/531,007, filed Dec. 18, 2003, the contents of which are hereby incorporated by reference.

### TECHNICAL FIELD

The present invention relates generally to fuel tank inerting systems. More particularly, the present invention relates to an on-board inert gas generation system (OBIGGS) wherein a nitrogen enriched, oxygen depleted stream is produced by an electrically pressurized air separation module.

### BACKGROUND OF THE INVENTION

Aircraft fuel tanks consist of thin walled shells that hold continuously varying amounts of jet fuel. The walls are thin to limit the weight of aircraft components. Such thin walls cannot support very much differential pressure between inside and outside as the fuel volume varies and, hence, must have a variable amount of gas to make up for the unfilled fuel volume and equalize the pressure. This fill gas must be “inert” so that accidental sparks from electrical appliances or static discharge cannot explode the gaseous mixture of fuel vapors and oxygen in the tank. On-board inert gas generation systems (OBIGGS) provide a fill gas with insufficient oxygen to sustain combustion.

Of available types of OBIGGS, the most desirable from a weight, capacity and ground service requirements standpoint are OBIGGS which utilize pressurized air. This air is separated into an oxygen rich component, which is exhausted overboard, and an oxygen depleted component, the inert gas, which is fed to the fuel tank.

A particular type of OBIGGS includes an air compressor to pump air into a separator which has two outputs: oxygen enriched air, and nitrogen enriched (or oxygen depleted) air. The oxygen enriched air is incidental. Nitrogen enriched air becomes the fill gas that is available in sufficient volume to keep the fuel tank inside/outside pressure differential within safe limits. The air compressor is driven by an electric motor and pressurizes the air that is pumped into the separator.

Compressing air to pass through the separator causes the air to heat up, and the temperature of the air becomes so great that downstream components could be damaged. Therefore the compressed air in the OBIGGS must be cooled before it passes into the separator. Additionally, there are other items in the system that require cooling, such as the compressor motor. Typically, the hot air is cooled by passing through thermally conductive passageways adjacent to separate flow paths of cooling air provided in a heat exchanger. At cruise speeds the cooling airflow is provided by ram air from outside the aircraft. However, on the ground and at low airspeed a “ground fan” must provide the cooling flow.

Unfortunately, there have been disadvantages associated with OBIGGS utilizing ground fans for providing air flow to cool the compressed air. Selection of the motors for the ground fans was typically based on size, weight, cost, reliability and their combinations. Minimum cost, size, and weight of the motor and fan would probably lead to selection of 28 vdc brush motors, but these require additional components, e.g., filters, to avoid electrical interference and are unquestionably the least reliable and possibly the heaviest systems because of the filter components. Brushless motors with built-in inverters improve the reliability and are in high production for other applications, but they also have additional electronic components to duplicate the commutation function of the brushes. Such brushless motors can be both heavy and expensive.

In view of the aforementioned shortcomings associated with OBIGGS and ground fans, there is a strong need in the art for an OBIGGS which overcomes such disadvantages.

### SUMMARY OF THE INVENTION

According to one aspect of the invention, an on-board inert gas generation system is provided. The system provides inert gas to a fuel tank of an aircraft and includes an air compressor for providing a supply of compressed air, the air compressor being driven by a compressor motor. The system further includes a separator for separating the inert gas from the compressed air provided by the air compressor, the inert gas being substantially oxygen depleted. In addition, the system includes an output for delivering the inert gas from the separator to the fuel tank, and a ground fan for providing air flow to cool the compressed air prior to the compressed air being separated by the separator, the ground fan being driven by a ground fan motor. Still further, the system includes an inverter/controller circuit for providing controlled electrical power to the compressor motor to control at least one of speed and torque of the compressor motor based on feedback provided from the compressor motor, and also providing the controlled electrical power to drive the ground fan motor.

According to another aspect of the invention, a method is presented for providing inert gas to a fuel tank of an aircraft. The method includes the steps of providing a supply of compressed air using an air compressor driven by a compressor motor; separating the inert gas from the compressed air provided by the air compressor, the inert gas being substantially oxygen depleted; delivering the inert gas from the separator to the fuel tank; using a ground fan to provide air flow to cool the compressed air prior to the compressed air being separated, the ground fan being driven by a ground fan motor; providing controlled electrical power to the compressor motor to control at least one of speed and torque of the compressor motor based on feedback provided from the compressor motor, and also providing the controlled electrical power to drive the ground fan motor.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a system block diagram of an on-board inert gas generation system in accordance with the present invention; and

FIG. 2 is an electrical schematic diagram of the compressor motor and ground fan motor of the on-board inert gas generation system in accordance with the present invention.

### DETAILED DESCRIPTION OF THE INVENTION

The present invention will now be described with reference to the drawings, wherein like reference numerals are used to refer to like elements throughout.

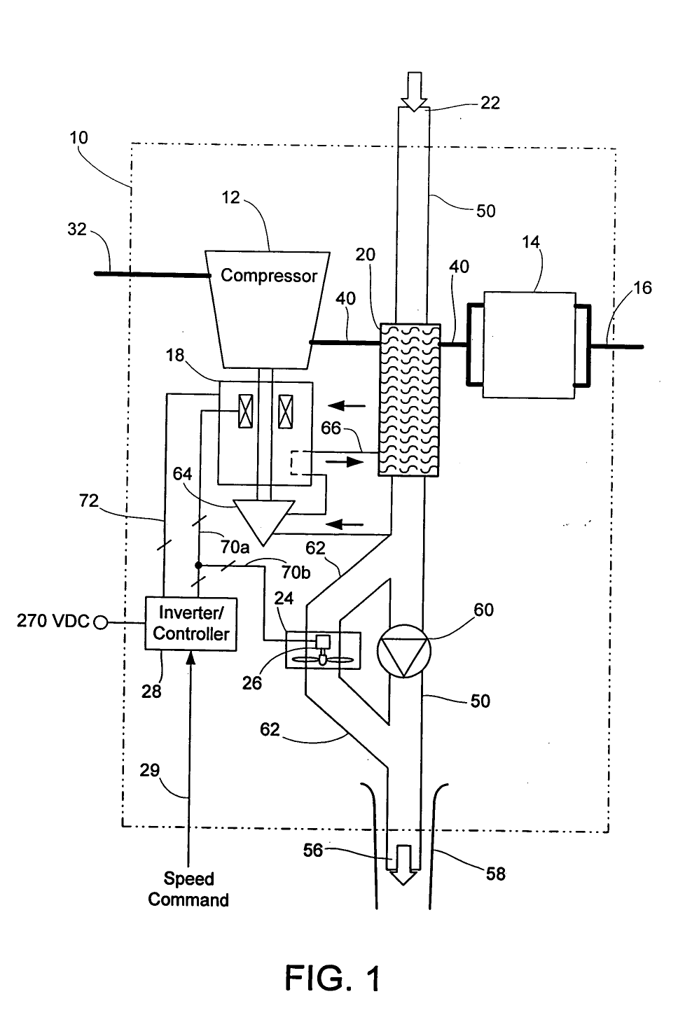

Referring initially to FIG. 1, an on-board inert gas generation system (OBIGGS) 10 is shown in accordance with the present invention. The relevant components of the OBIGGS 10 include an air compressor 12 that provides compressed air to a separator 14. The separator 14 separates the compressed air into nitrogen enriched (or oxygen depleted) air and oxygen enriched air. The nitrogen enriched air becomes the fill gas and is provided via an output 16 to the aircraft fuel tank(s) (not shown). The compressor 12 is driven by a motor 18 designed to provide sufficient horsepower and torque to compress the air provided to the separator 14.

The OBIGGS 10 further includes a heat exchanger 20 that serves to cool the compressed air provided by the compressor 12 prior to being delivered to the separator 14. The heat exchanger 20 in the exemplary embodiment is a series of thermally conductive passageways that allow separate flow paths of the compressed air and cooling air to interact in order to cool the compressed air. A ram air inlet 22 provides the cooling air to the heat exchanger 20. At cruising speeds, the air pressure at the ram air inlet 22 is sufficient to drive the cooling air flow through the heat exchanger 20. While the aircraft is on the ground or at slow speeds, however, the air pressure at the ram air inlet 22 may not be sufficient. Accordingly, the OBIGGS 10 includes a ground fan 24 designed to provide sufficient cooling air flow through the heat exhanger 20. The ground fan 24 is driven by a ground fan motor 26.

In accordance with the invention, the compressor motor 18 is electrically powered and controlled by power electronics within an inverter/controller 28. The inverter/controller 28 can modulate the speed and torque of the compressor motor 18 to the appropriate levels for providing compressed air to the separator 14. In the exemplary embodiment, the inverter/controller 28 provides three phase variable frequency and voltage to the compressor motor 18 in response to a speed command 29.

Still further in accordance with the invention, the same inverter/controller 28 also provides electrical power and control to the ground fan motor 26. This is contrary to the conventional approach where the compressor motor and ground fan motor each have their own respective inverter/controller. Those having ordinary skill in the art and having read the description provided herein will appreciate that since normal operation of the OBIGGS 10 on the ground occurs during a narrow range of speed/torque, the voltage and frequency of the compressor motor 18 will be in a similarly narrow range. This relatively narrow range occurs when the ground fan 24 and ground fan motor 26 must operate properly.

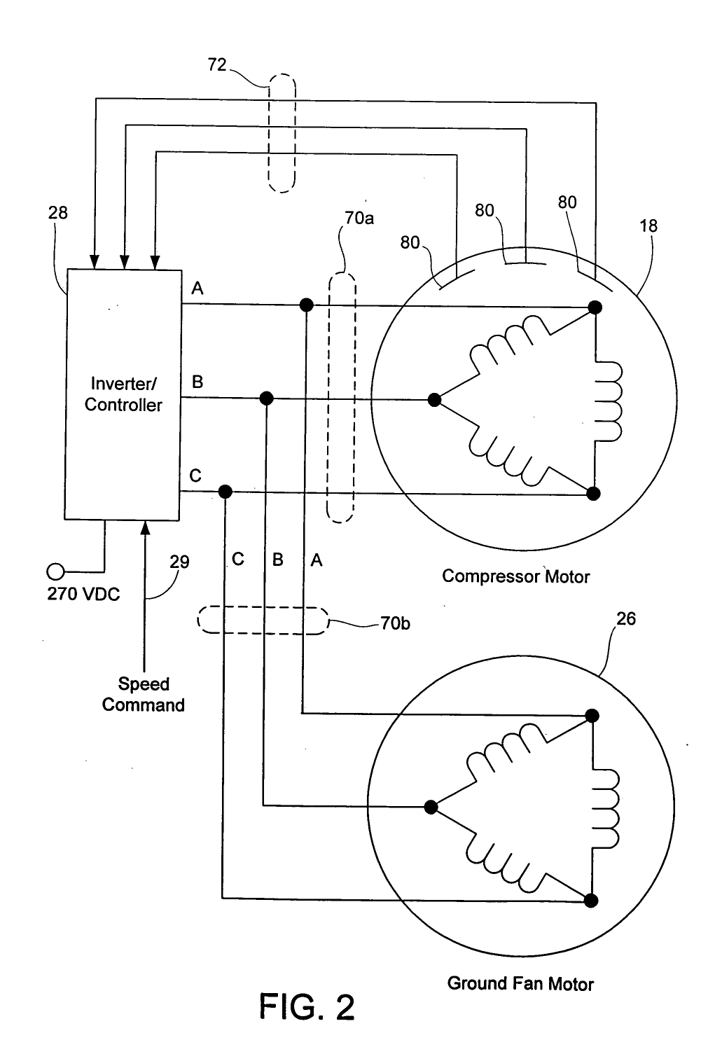

Therefore, the ground fan 24 and motor 26 can be designed using a brushless motor to provide enough cooling flow at the worst-case combination of compressor motor frequency/voltage and environmental parameters. It will be over-designed for all other conditions. As is explained more fully below in connection with FIG. 2, the ground fan 24 and motor 26 become a slave to the compressor motor 18 as driven by the inverter/controller 28. The ground fan motor 26 may be either asynchronous (typically an induction motor) or synchronous (typically a permanent magnet or hysteresis motor). The ground fan 24 and motor 26 may run either at constant speed dictated by the worst case combination of temperatures, heat loads, and pressures, or be cycled on/off to minimize power consumption or optimize some other condition.

As will be appreciated, the OBIGGS 10 in accordance with the present invention eliminates the need for brushes and their additional filter components, other power inverters normally used to replace the brushes, and dependence upon a separate power source for the ground fan 24. Design of the motor 26 is an additional non-recurring cost, but the overall system cost in production is minimized while reliability is improved by a large factor.

Continuing to refer to FIG. 1, operation of the OBIGGS 10 will now be explained. The system 10 draws in air via an inlet line 32. The compressor 12 compresses the air and provides the compressed air to the heat exchanger 20 via line 40. Line 40 provides a flowpath through the heat exchanger 20 which is in thermal conduction with a separate cooling air flowpath provided in the heat exchanger 20 via the ram air inlet 22.

The compressed air in line 40 is forced through the separator 14, which serves to separate the compressed air into oxygen enriched air and nitrogen enriched (or oxygen depleted) air. The nitrogen enriched air, serving as the inert gas, is provided by the separator 14 to the aircraft fuel tank(s). The oxygen enriched air from the separator 14 is exhausted overboard.

Ram air is input to a ram air line 50 via the ram air inlet 22. The ram air line 50 serves as the separate flow path for the cooling air flow provided through the heat exchanger 20. The cooling air flow continues through the heat exchanger 20 in line 50, and proceeds out an outlet 56. In the exemplary embodiment, the aircraft includes a vent system 58 which vents the ram air outlet 56 and exhausted oxygen rich air in line 44 into the ambient environment.

The ram air line 50 includes a ram air check valve 60 as shown. In addition, bypassing the check valve 60 is the ground fan bypass line 62. The ground fan bypass line 62 includes the ground fan 24. The ground fan 24 serves to draw cooling air through the heat exchanger 20 in order to provide cooling air flow even when the aircraft is on the ground or traveling at low speed. As noted the ground fan 24 draws the cooling air through the heat exchanger 20 in the exemplary embodiment. However, it will be appreciated that the ground fan 24 could be located so as to drive the cooling air through the heat exchanger 20 without departing from the scope of the invention.

In the exemplary embodiment, the compressor motor 18 includes its own internal motor fan 64. The OBIGGS 10 includes a separate flowpath 66 which serves to circulate cooling air for cooling the motor 18, motor bearings, etc. The flowpath 66 also passes through the heat exchanger 20 so as to cool the air within the flowpath 66 before returning to the motor 18.

As is shown in FIG. 1, the inverter/controller 28 receives an operating voltage of 270 volts DC in order to provide power to and control the compressor motor 18 and fan motor 26. An operating voltage of 270 VDC is provided as such voltage is typical of the power available on an aircraft. However, it will be appreciated that the present invention may be utilized with other operating voltages without departing from the scope of the invention.

Speed commands are provided to the inverter/controller 28 via a main processor/controller (not shown). In the exemplary embodiment, the inverter/controller 28 controls the frequency and voltage of the power provided to the compressor motor 18 and fan motor 26 based on the speed commands from the main processor/controller. Such speed commands may be based on various temperature and pressure measurements taken throughout the system 10 as will be appreciated.

The inverter/controller 28 provides power to both the compressor motor 18 and the fan motor 26 via power lines 70a and 70b. In the exemplary embodiment, the compressor motor 18 and the fan motor 26 are both multiphase motors (e.g., three-phase). The inverter/controller 28 converts the DC power provided by the aircraft into multiphase AC power using conventional techniques, and provides the multiphase power to each of the compressor motor 18 and the fan motor 26 on lines 70a and 70b. Rotor position sensors 80 in the compressor motor 18 in turn provide position signals back to the inverter/controller 28 via control lines 72.

As noted above, the fan motor 26 thus becomes a slave to the compressor motor 18 insofar as control. The fan motor 26 does not require its own inverter/controller.

FIG. 2 illustrates the compressor motor 18, ground fan motor 26 and inverter/controller 28 in more detail. In the exemplary embodiment, the motors 18 and 26 are both three-phase motors and are wired in a delta-configuration. It will be appreciated, however, that the motors 18 and 26 could have another number of phases or be wired in a wye-configuration without departing from the scope of the invention.

As is shown, the multiphase output (e.g., lines A, B and C) from the inverter/controller 28 is provided in parallel to both the compressor motor 18 and the ground fan motor 26. Specifically, lines 70a provide the multiphase power to the compressor motor 18 and lines 70b provides the same multiphase power to the ground fan motor 26. Rotor position sensors 80 within the compressor motor 18 provide feedback signals to the inverter/controller 28 via lines 72. As is known, the sensors 80 sense the position of the rotor within the compressor motor 18. Based on such position information, the inverter/controller 28 controls the magnitude and phase of the power output on lines 70a and 70b. Since such control is based only on the position of the compressor motor 18, however, the ground fan motor 26 operates purely as a slave.

Normal operation of the OBIGGS 10 on the ground occurs during a narrow range of speed/torque. Consequently, the voltage and frequency provided to the compressor motor 18 will be in a similarly narrow range. This relatively narrow range occurs when the ground fan 24 and ground fan motor 26 must operate.

Therefore, the ground fan 24 and ground fan motor 26 can be designed using a brushless motor to provide enough cooling flow at the worst-case combination of compressor motor frequency/voltage and environmental parameters. The ground fan 24 and motor 26 simply will be over-designed for all other conditions. Furthermore, the ground fan 24 and motor 26 may run either at constant speed dictated by the worst case combination of temperatures, heat loads, and pressures, or be modulated to minimize power consumption or optimize some other condition.

In the exemplary embodiment, the compressor motor 18 is a synchronous motor such as a permanent magnet or hysteresis type synchronous motor. The ground fan motor 26 may be either a synchronous motor or an asynchronous motor, such as an induction motor. As will be appreciated, the electrical power necessary to drive the compressor motor 18 will be an order of magnitude greater than that necessary to drive the ground fan motor 26. Thus, the ground fan motor 26 will have less stringent efficiency requirements compared to the compressor motor 18 and can be an induction motor or other non-synchronous motor.

By simply providing the multiphase power output by the inverter/controller 28 in parallel to the compressor motor 18 and ground fan motor 26, the inverter/controller 28 provides synchronous multi-phase AC power to the compressor motor 18 while the ground fan motor 26 responds to whatever frequency and voltage is applied to the compressor motor 18. If the compressor motor 18 speeds up in response to a command for it to do so, the ground fan motor 26 will also speed up to provide increased cooling, and vice versa.

Those having ordinary skill in the art will therefore appreciate that the OBIGGS 10 in accordance with the present invention eliminates the need for brushes and their additional filter components, other power inverters normally used to replace the brushes, and dependence upon a separate power source for the ground fan 24. As mentioned above, design of the motor 26 is an additional non-recurring cost. However, the overall system cost in production is minimized while reliability is improved by a large factor.

Although the invention has been shown and described with respect to certain preferred embodiments, it is obvious that equivalents and modifications will occur to others skilled in the art upon the reading and understanding of the specification. For example, according to another embodiment of the invention the inverter/controller 28 does not rely on position sensors 80 for sensing the position of the rotor in the compressor motor 18. Rather, for example, a computer software system using known techniques estimates rotor position by observing the current and voltage of the various phases of power. The ground fan motor 26 in such case increases the noise level in the software algorithm for estimating rotor position. However, the relatively low power of the ground fan motor allows the increase in noise level to have only minor effect.

The present invention includes all such equivalents and modifications, and is limited only by the scope of the following claims.

1. An on-board inert gas generation system for providing inert gas to a fuel tank of an aircraft, comprising:
an air compressor for providing a supply of compressed air, the air compressor being driven by a compressor motor;
a separator for separating the inert gas from the compressed air provided by the air compressor, the inert gas being substantially oxygen depleted;
an output for delivering the inert gas from the separator to the fuel tank;
a ground fan for providing air flow to cool the compressed air prior to the compressed air being separated by the separator, the ground fan being driven by a ground fan motor;
an inverter/controller circuit for providing controlled electrical power to the compressor motor to control at least one of speed and torque of the compressor motor based on feedback provided from the compressor motor, and also providing the controlled electrical power to drive the ground fan motor.

2. The system of claim 1, wherein both the compressor motor and the ground fan motor are each a brushless N-phase AC motor, where N is an integer greater than one.

3. The system of claim 1, wherein the compressor motor is a synchronous motor.

4. The system of claim 3, wherein the ground fan motor is an asynchronous motor.

5. The system of claim 3, wherein the ground fan motor is a synchronous motor.

6. The system of claim 1, wherein the controlled electrical power from the inverter/controller circuit is coupled in parallel to the compressor motor and to the ground fan motor.

7. The system of claim 6, wherein the inverter/controller circuit provides variable frequency and voltage control to the compressor motor, and the ground fan motor receives the same frequency and voltage as the compressor motor.

8. The system of claim 7, wherein the ground fan motor is designed to provide sufficient cooling air flow at a worst-case combination of frequency, voltage, and environmental parameters.

9. The system of claim 1, wherein the system comprises a heat exchanger through which the compressed air and the cooling air flow each pass in order to cool the compressed air.

10. The system of claim 9, wherein the ground fan provides primary cooling air flow through the heat exchanger when the aircraft is on the ground.

11. A method for providing inert gas to a fuel tank of an aircraft, comprising the steps of:
providing a supply of compressed air using an air compressor driven by a compressor motor;
separating the inert gas from the compressed air provided by the air compressor, the inert gas being substantially oxygen depleted;
delivering the inert gas from the separator to the fuel tank;
using a ground fan to provide air flow to cool the compressed air prior to the compressed air being separated, the ground fan being driven by a ground fan motor;
providing controlled electrical power to the compressor motor to control at least one of speed and torque of the compressor motor based on feedback provided from the compressor motor, and also providing the controlled electrical power to drive the ground fan motor.

12. The method of claim 11, wherein both the compressor motor and the ground fan motor are each a brushless-phase AC motor, where N is an integer greater than one.

13. The method of claim 11, wherein the compressor motor is a synchronous motor.

14. The method of claim 13, wherein the ground fan motor is an asynchronous motor.

15. The method of claim 13, wherein the ground fan motor is a synchronous motor.

16. The method of claim 11, wherein the controlled electrical power is provided in parallel to the compressor motor and to the ground fan motor.

17. The method of claim 16, wherein the ground fan motor receives the same frequency and voltage as the compressor motor.

18. The method of claim 17, wherein the ground fan motor is designed to provide sufficient cooling air flow at a worst-case combination of frequency, voltage, and environmental parameters.

19. The method of claim 11, further comprising the step of using a heat exchanger through which the compressed air and the cooling air flow each pass in order to cool the compressed air.

20. The method of claim 19, wherein the ground fan provides primary cooling air flow through the heat exchanger when the aircraft is on the ground.

21. The method of claim 20, wherein ram air provides primary cooling air flow through the heat exchanger when the aircraft is at cruising speed.
